(19) United States
(12) Patent Application Publication
(10) Pub. No.: US 2021/0069869 A1
(43) Pub. Date: Mar. 11, 2021

(54) Self-locking clamp

(71) Applicant: Pontus Göth, Stockholm (SE)

(72) Inventor: Göran Rolf Ewerlöf, Stockholm (SE)

(73) Assignee: Pontus Göth

(21) Appl. No.: 17/012,819

(22) Filed: Sep. 4, 2020

(30) Foreign Application Priority Data
Sep. 6, 2019 (SE) 1951021-3

(51) Int. Cl. B25B 5/04

(52) U.S. Cl. CPC B25B 5/04

(57) ABSTRACT

Self-locking clamp having two clamping jaws (307), a shank (11) connected to clamping jaws (307), and a central part (201). Each jaw (307) is fastened in an articulated manner to the central part (201) via a first flexible connection (9), and the shank (11) has two parts (12, 13) that are connected in an articulated manner to one another at adjacent ends via a second flexible connection (14). The shank (11) is fastened in an articulated manner via a third flexible connection (15) to the one clamping jaw (307) and is fastened in an articulated manner via a fourth flexible connection (17) to the central part (201). The central part (201) is formed such that the shank (11) can assume a snapped-over position adjacent the central part (201) forming a first lock for the shank (11). The clamp also has a second lock (40) holding the shank (11) when snapped-over.

### TECHNICAL FIELD

The present invention refers to a self-locking clamp comprising two clamping jaws and two shanks connected to the clamping jaws, and in particular an improved clamp provided with means maintain locking even when exposed to wear and overload.

### BACKGROUND

In European Patent No. 2 606 243 is disclosed a self-locking clamp that comprises two clamping jaws and two shanks connected to the clamping jaws. The clamp in accordance with the this known device is distinguished in that it comprises a central part, that at least the one clamping jaw is fastened in an articulated manner to the central part via a first flexible connection, that at least the one shank comprises two parts that are connected in an articulated manner to one another at adjacent ends via a second flexible connection that the shank is fastened in an articulated manner via a third flexible connection to the one clamping jaw, that the shank is fastened in an articulated manner via a fourth flexible connection to the central part, and that the central part is formed in such a manner that the one shank can assume a snapped-over position following the central part.

Further, the clamp therein is provided with lockable jaws. With the help of the knee arms (shanks), the jaws are kept tightly compressed when in the locked position. A precondition for the shanks to stay in the locked snapped-over position is that there is a pre-tension in the design when the jaws are closed. It is such a pre-tension acting on the shanks that is critical for locking the clamp. This may mean that there is a pressure between the closed jaws even without clamping any object between them.

However, as wear and tear sets in and possible overload, for instance, by clamping larger pieces than intended, the clamp may deform somewhat and thereby suffer from a degradation of the clamping force or the ability to stay locked in a snapped-over shank position. The shanks have a tendency to retain their original position, typically the position in which they were manufactured by injection molding plastic material.

Through this reference, the contents of European Patent No. 2 606 243 are incorporated herein in their entirety.

Thus, there is a demand for an improved clamp having a secure locking. The object of the present invention is to achieve such a clamp that removes, or at least mitigates, some or all of the drawbacks of presently known self-locking clamps.

### SUMMARY

The above-mentioned objects are achieved by the present invention according to the independent claim. Preferred embodiments are set forth in the dependent claims.

The self-locking clamp of the invention comprises two clamping jaws and at least one shank connected to the at least one clamping jaw, the clamp comprises a central part, the at least one clamping jaw is fastened in an articulated manner to the central part via a first flexible connection, and that the at least the one shank comprises two parts that are connected in an articulated, manner to one another at adjacent ends via a second flexible connection, the shank is fastened in an articulated manner via a third flexible connection to the one clamping jaw, that the shank is fastened in an articulated manner via a fourth flexible connection to the central part, and that the central part is formed in such a manner that the one shank can assume a snapped-over position adjacent the central part thus forming a first lock for the shank, characterized in that the clamp further comprises a second lock which holds the shank in the snapped-over position. This enables the clamp to have a longer life and a maintained function as it ages.

Preferably, the second lock has first and second lock parts formed to mate with one another, the first lock part is attached to the shank and the second lock part is attached to the central part.

Advantageously, the parts of the second lock are formed as a lock seat and a flexible lock arm, respectively, and wherein one end of the flexible lock arm is configured to mate with the lock seat in the snapped-over position of the shank. This may be realized by the second lock part being the flexible lock arm, and the clamp is formed such that any tension in the flexible lock arm is essentially unrelated to tension in the clamping jaws.

Advantageously, the second lock is configured to release by pressing on the shank part, located distally to the jaws, at a position distally from that shank part's articulated connection to the other shank part.

For cost-efficiency and durability, the clamping jaws, the shank, the central part, and the first and second locks are formed as a single integrated piece.

### BRIEF DESCRIPTION OF THE DRAWINGS

FIGS. 1-3 show various variation of a prior art clamp.

FIG. 4 is a plane side view of the clamp according to the present invention in an open state.

FIG. 5 is a plane side view of the clamp according to the present invention in a closed state.

FIG. 6 is a perspective view of the clamp according to the present invention in an open state.

FIG. 7 is a perspective view of the clamp according to the present invention in a closed state.

### DETAILED DESCRIPTION

The clamp will now be described in detail with references to the appended figures. Throughout the figures the same, or similar, items have the same reference signs. Moreover, the items and the figures are not necessarily to scale, emphasis instead being placed upon illustrating the principles of the invention.

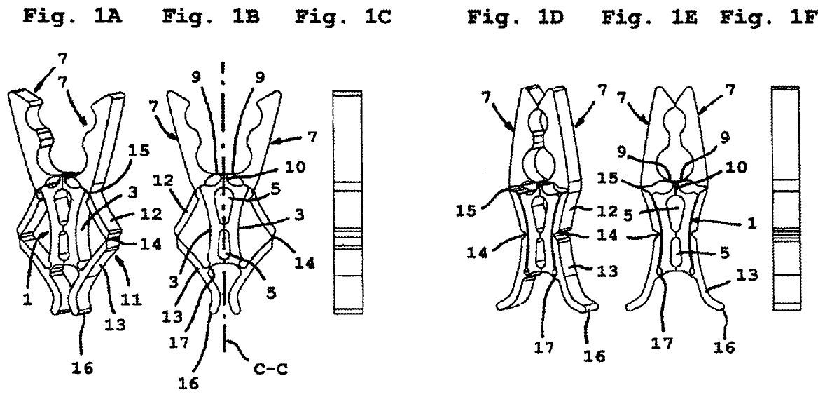

As a background to the present invention various variations of the clamp disclosed in EP2606243 will be described with references to FIGS. 1-3.

The self-locking clamp in accordance with the prior art device is shown in FIG. 1A-1F is in the form of a clothes peg and comprises a central part 1 distinguished in that it comprises two concave side parts 3. According to the embodiment shown the central part 1 and also the clamp are for the rest symmetrical as regards the centre line C-C extending in dots and dashes in FIG. 1B. According to the embodiment shown the centre part 1 has a longer extension along the centre line C-C than transversely to the centre line C-C. According to the embodiment shown the centre part 1 is not solid but rather provided with through holes 5 in order to achieve a savings of material and also a reduction of weight. It is pointed out in this connection that sufficient material must remain in the centre part 1 so that it will display sufficient rigidity for fulfilling its function. It is also pointed out in this connection that the shaping of the centre part is in no way limited to the shape shown in FIG. 1B.

Two clamping jaws 7 in the self-locking clamp are connected in an articulated manner to the centre part 1, whereby a first flexible connection 9 is effected by a first material part extending between a projecting part 10 in the centre part 1 and the respective clamping jaw 7. The first material parts 9 have relatively little thickness. It should be pointed out in this connection that it should be taken into account during the dimensioning of the first flexible connections/the first material parts 9 that the first connections between the centre part 1 and the clamping jaws 7 should be permanent and at the same time flexible, i.e., that the clamping jaws 7 can pivot in the main plane of the clamp relative to the centre part 1. As concerns the clothes peg shown in FIG. 1A-1F, the parts of the clamping jaws 7 facing one another are formed in a relatively conventional manner, as is already known for clothes pegs. It should be pointed out in this connection that the shaping of the parts facing one another in the clamping jaws 7 is in no way limited to the shaping shown in FIG. 1A-1F.

The self-locking clamp/clothes peg shown in FIG. 1A-1F also comprises two shanks 11, which generally extend along the longitudinal, concave side parts 3 of the central part 1. Each of the shanks 11 comprises two parts 12 respectively 13 that are mutually connected at their adjacent ends by a second flexible connection 14. The end of each of the upper parts 12 which end faces away from the second flexible connection 14 is connected to the associated clamping jaw 7 by a third flexible connection 15, whereby this third connection 15 is connected to a lower, outer part of the clamping jaw 7, i.e., viewed in a plane view the third flexible connection 15 is located at the side of the associated first flexible connection 9.

The lower free end of the lower part 13 in each shank 11 is formed like a gripping part 16, whereby this gripping part 16 is bow-shaped and swung out. In an intermediate part the lower part 13 is connected to a lower corner in centre part 1 by a fourth flexible connection 17.

As concerns the flexible connections 9, 14, 15, 17 in the self-locking clamp these connections can advantageously be formed in a similar manner, i.e., they consist of a relatively thin material part that allows a large number of actuations without wearing out.

The function of the self-locking clamp in accordance with FIG. 1A-1F will now be described. In the position shown in FIG. 1A-1C the self-locking clamp is open, i.e., the clamping jaws 7 are distanced from one another. This is brought about in that the gripping parts 16 in the lower parts 13 of the shanks 11 are moved against each other, e.g., in that the user presses the gripping parts 16 against one another with his one hand. As is most clearly apparent from FIG. 1B, the shanks 11 come to introduce a force on the clamping jaws 7 here that causes the clamping jaws 7 to rotate/pivot around the first flexible connections 9. The parts 12 and 13 of the shanks 11 move into the position shown in FIG. 1b, which is made possible by the second flexible connection 14 between parts 12 and 13. When the self-locking clamp assumes the position shown in FIG. 1A-1C it can be applied, for example, around a clothesline and the article of clothing that is to be carried by the clothesline. When the clothesline and article of clothing are located between the clamping jaws 7 the self-locking clamp is transferred to the position shown in FIG. 1D-1F, which is done by the user by pressing the shanks 11 against one another so that they assume the position shown in FIG. 1D-1E, i.e., the shanks 11 were brought to rest against the concave side parts 3 of the centre part 1, whereby the shanks 11 assumed a so-called snapped-over position.

It can be seen from a study of FIG. 1E that if a separating force is applied on clamping jaws 7, the shanks 11 are pressed harder against the side parts 3 in the centre part 1 on account of the snapped-over position. The clamp according to FIG. 1A-1F is thus self-locking.

In order to open the self-locking clamp the user shifts the gripping parts 16 towards one another and the clamp is transferred to the position shown in FIG. 1A-1C.

The embodiment of a self-locking clamp in accordance with the prior art device shown in FIG. 2A-2F constitutes a forceps. Conceivable areas of application are in medical treatment where a forceps can be used in surgery in order to stop bleeding by clamping blood vessels together. A forceps can also be used in order to clamp tubes together in the case of extracorporeal blood treatment such as dialysis, thoracic surgery, etc.

The clamp according to FIG. 2A-2F is in principle identical to the clamp shown above in accordance with FIG. 1A-1F as concerns the centre part 1, the connections 9, 14, 15, 17 and the shanks 11. For this reason the same reference numerals are used when the parts are the same as the ones used in FIG. 1A-1F. The principle difference that the device according to FIG. 2A-2F has in comparison to the device according to FIG. 1A-1F is the form of clamping jaws 107. As is apparent from FIG. 2A-2F each of the clamping jaws 107 has a plane part 120 located nearest to the central part 1 that is intended to rest against the opposing plane part 120 of the other clamping jaw 107 in the active position. Outside the plane part 120, i.e., further away from central part 1, each of the clamping jaws 107 has a recess 121 that according to the embodiment shown is semi-circular in a plane view. In the active position recess 121 forms a circular opening with the corresponding recess 121 in the other clamping jaw 107. In front of recess 121, i.e., further away from central part 1, each of clamping jaws 107 has a toothed part 122, 123 with profilings, whereby the profilings in the one toothed part 122 match the profilings in the other toothed part 123. This is most clearly apparent from FIGS. 2D and 2E, where the toothed parts 122, 123 tightly abuts one another.

As regards the self-locking function of the clamp in accordance with FIG. 2A-2F reference is made to what was said previously when the clamp in accordance with FIG. 1A-1F was concerned. As was stated previously, the structural design of the central part 1 and of the shanks 11 is in principle identical for both variations.

The variation of the self-locking clamp according to the prior art device and shown in FIG. 3A-3F comprises two halves. Concerning the one half of the clothes peg according to 3A-3F, it is in principle identical to the one half of the clamp/clothes peg shown in 1A-1F. For this reason this one half of the clamp/the clothes peg according to FIG. 3A-3F has been given reference numerals corresponding to the ones in FIG. 1A-1F.

As concerns the central part 201, it is in principle halved in comparison to the central part 1 in accordance with the above-described embodiments, i.e., the central part 201 comprises a concave side part 203.

The clamp/clothes peg according to FIG. 3A-3F also comprises a second half in the form of a rigid/stiff part 230. This rigid/stiff part 230 has a great similarity to the one half of a conventional clothes peg, i.e., the rigid/still part 230 comprises a rigid clamping jaw 207 and a rigid shank 211, whereby the clamping jaw 207 and the shank 211 are integrated with one another. The stiff part 230 is connected to the central part 201, whereby through holes 205 are included in the connection area between the stiff part 230 and the central part 201. It should be pointed out in this connection that the form of the rigid/stiff part 230 is in no way limited to the form shown in FIG. 3A-3F.

As concerns the function of the clamp/clothes peg according to FIG. 3A-3F, the half that is in principle identical to the one half in the embodiment according to FIG. 1A-1F functions in a manner corresponding to this one half in the embodiment according to FIG. 1A-1F. Therefore, reference is made to the above functional description of the embodiment according to FIG. 1A-1F.

In the embodiments described above the central part 1; 201 comprises at least one concave side part 3; 203, whereby the flexible shank 11 rests against the concave side part 3; 203 in a snapped-over position. In the framework of the present invention the central part does not have to be provided with concave side parts. By way of an exemplifying and non-limiting measure it can be stated that the side part can be constituted by two plane parts that meet in a tip, i.e., the side part is slightly V-shaped in a plane view.

The self-locking clamp in accordance with the present invention builds on the prior art clamp described above. Polypropene appears to be a particularly suitable material for manufacturing of the inventive clamp. It can be produced, e.g., by injection moulding or extrusion.

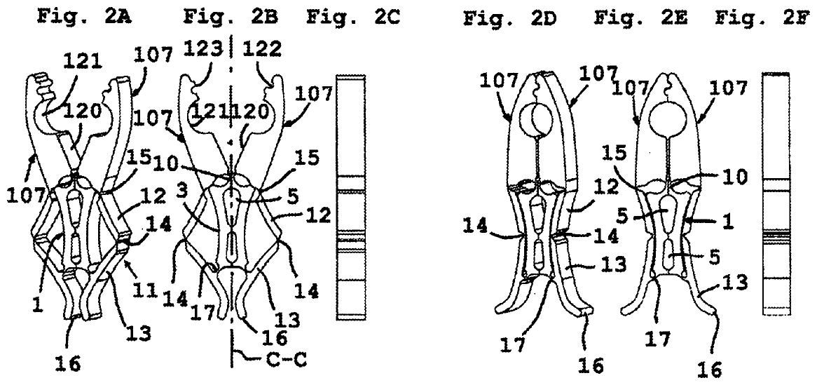

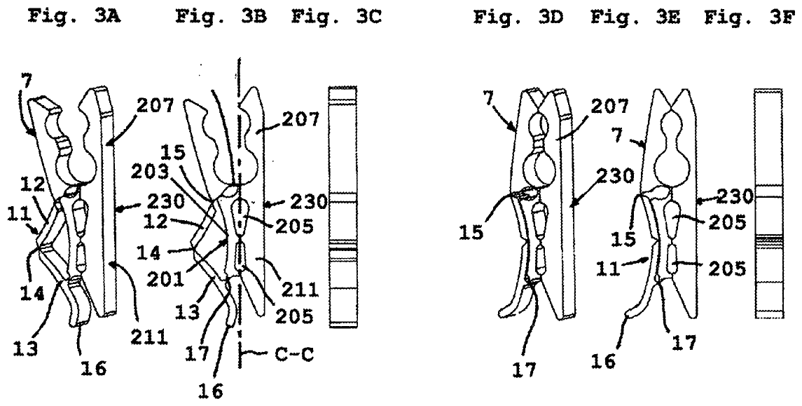

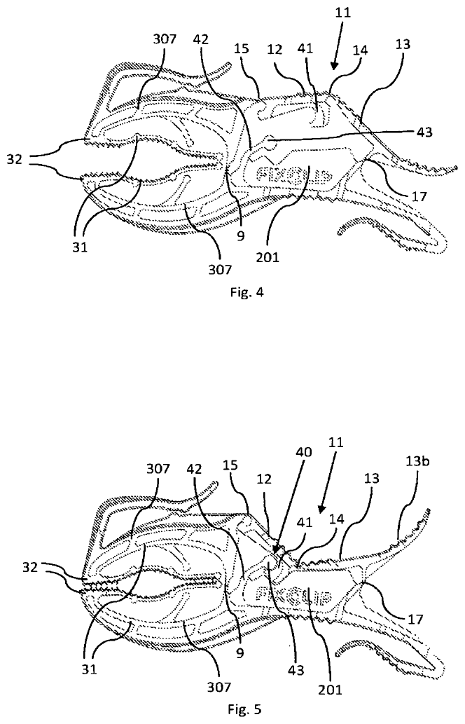

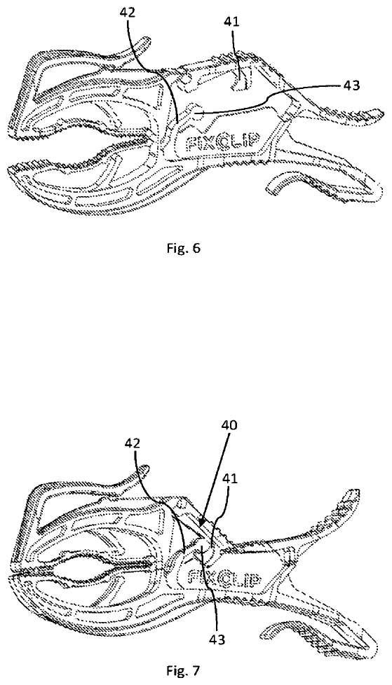

With references to FIGS. 4-7 the clamp according to the present invention will now be described in detail. As stated above the present invention is based upon the self-locking clamp described above. Variations of the above-described clamp are applicable to clamp according to the present invention.

The present invention relates to a self-locking clamp that comprises two clamping jaws 307 and at least one shank 11 connected to the at least one clamping jaw 307. The clamp comprises a central part 201, and the at least one clamping jaw 307 is fastened in an articulated manner to the central part 201 via a first flexible connection 9.

The at least the one shank 11 comprises two parts 12, 13 that are connected in an articulated manner to one another at adjacent ends via a second flexible connection 14, the shank 11 is fastened in an articulated manner via a third flexible connection 15 to the one clamping jaw 307. Furthermore, the shank 11 is fastened in an articulated manner via a fourth flexible connection 17 to the central part 201, and that the central part 201 is formed in such a manner that the one shank 11 can assume a snapped-over position adjacent the central part 201. The features as described above correspond generally to embodiments in the above describe prior art device.

Each of the two clamping jaws is provided with an inner jaw member 31, wherein the inner jaw member 31 has curvature surface for clamping items such as laundry and a laundry line. It further has a first end 32 attached to a tip end of the clamping jaw and a second end 33 which is a free end close to an inner surface of the clamping jaw. Each inner jaw member 31 is supported by an inner jaw arm attached in an inner surface of the corresponding jaw and is intended for creating an elevated pressure between the inner jaws in closed position, typically closer to the free second end 33 than to the first end 32.

Each inner jaw member 31 is elastic and flexible and is provided with a friction-increasing surface (34) facing the other inner jaw member to increase the friction towards e.g. laundry held by the clamp. The shown friction-increasing surface is a serrated surface. However, numerous friction-increasing surfaces may be contemplated, e.g. a roughened surface.

To address the problem related to wear or deformation of the clamp, it has a first and a second locks which holds the shank in the snapped-over position. The first lock is attained through the snap-over function in itself. The second lock 40 is locking, typically independently, the shank 11 in the locked snapped-over position, even in a situation where the snap-over lock function is weakened, possibly seriously weakened by substantial deformation of the clamp.

The second lock 40 has first and second lock parts formed to mate with one another, the first lock part is attached to the shank 11 and the second lock part is attached to the central part 201.

The parts of the second lock 40 are formed as a lock seat (or hook) 41 and a flexible lock arm 42, respectively, and wherein one end 43 of the flexible lock arm 42 is configured to mate with the lock seat 41 in the snapped-over position of the shank 11. The mating end 43 of the lock arm 42 is typically formed as a ball or cylinder oriented to engage with the lock seat (or hook). Several other shapes of mating portions of the second lock 40 are possible.

The second lock part is typically formed by the flexible lock arm 42 and the clamp is formed such that any tension in the flexible lock arm 42 is essentially unrelated to tension in the clamping jaws 307.

The second lock 40 is configured to release by pressing on the shank part 13, located distally to the jaws 307, at a position 13b distally from that shank part's 13 articulated connection to the other shank part 12, on the opposite side of articulation 17.

The clamping jaws 307, the shank 11, the central part 201, and the first and second locks are formed as a single integrated piece and, preferably, so are all parts of the clamp.

The inventive clamps are provided with first and second hooks for hanging on a washing line or for hanging laundry on. The jaws may be used for hanging the clamp upside down from the washing line and then using a hook for hanging laundry on.

The present invention is not limited to the above-described preferred embodiments. Various alternatives, modifications and equivalents may be used. Therefore, the above embodiments should not be taken as limiting the scope of the invention, which is defined by the appending claims.

1. A self-locking clamp that comprises two clamping jaws (307) and at least one shank (11) connected to the at least one clamping jaw (307), the clamp comprises a central part (201), the at least one clamping jaw (307) is fastened in an articulated manner to the central part (201) via a first flexible connection (9), and that the at least the one shank (11) comprises two parts (12, 13) that are connected in an articulated manner to one another at adjacent ends via a second flexible connection (14), the shank (11) is fastened in an articulated manner via a third flexible connection (15) to the one clamping jaw (307), that the shank (11) is fastened in an articulated manner via a fourth flexible connection (17) to the central part (201), and that the central part (201) is formed in such a manner that the one shank (11) can assume a snapped-over position adjacent the central part (201) thus forming a first lock for the shank (11), characterized in that the clamp further comprises a second lock (40) which holds the shank (11) in the snapped-over position.

2. The self-locking clamp according to claim 1, wherein the second lock (40) has first and second lock parts formed to mate with one another, the first lock part is attached to the shank (11) and the second lock part is attached to the central part (201).

3. The self-locking clamp according to claim 1 or 2, wherein the parts of the second lock are formed as a lock seat (41) and a flexible lock arm (42), respectively, and wherein one end (43) of the flexible lock arm (42) is configured to mate with the lock seat (41) in the snapped-over position of the shank (11).

4. The self-locking clamp according to any of claims 1-3, wherein the second lock part is the flexible lock arm (42) and the clamp is formed such that any tension in the flexible lock arm (42) is essentially unrelated to tension in the clamping jaws (307).

5. The self-locking clamp according to any of claims 1-4, wherein the second lock (40) is configured to release by pressing on the shank part (13), located distally to the jaws (307), at a position (13b) distally from that shank part's (13) articulated connection to the other shank part (12).

6. The self-locking clamp according to any of claims 1-5, wherein the clamping jaws (307), the shank (11), the central part (201), and the first and second locks are formed as a single integrated piece.
